(19) United States
(12) Patent Application Publication
(10) Pub. No.: US 2007/0015483 A1
(43) Pub. Date: Jan. 18, 2007

(54) Mobile phone radio

(75) Inventors: James Scales, Berkshire (GB); Robert Nichols, Hampshire (GB)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/452,504

(22) Filed: Jun. 13, 2006

(30) Foreign Application Priority Data
Jun. 14, 2005 (GB) 0512058.9

(51) Int. Cl. H04B 1/16; H04B 1/38; H04M 1/00

(52) U.S. Cl. 455/343.1; 455/574

(57) ABSTRACT

Apparatus arranged to have an apparatus active state and an apparatus idle state, the apparatus including an RDS engine having an engine active state and an idle state, and wherein the RDS engine is arranged to be placed in the engine active state based upon whether the apparatus is in the apparatus active state.

### FIELD OF TECHNOLOGY

This invention is concerned with mobile telephones or terminals that contain radio receivers, in particular radio receivers with Radio Data System (RDS) functionality.

### BACKGROUND OF THE INVENTION

The decoding of RDS radio data in Very High Frequency (VHF) Frequency Modulation (FM) radio receivers requires software or hardware processing. In some architectures, this requires a system clock. However, battery consumption is increased whenever the system clock is running. This is a drawback in mobile terminals where there is a desire to minimise battery consumption. Incorporating RDS Data reception in a mobile phone or terminal may be considered too much of a drain, on battery life. Accordingly, users may be reluctant to leave RDS Data reception active at all times which could be detrimental to the use of RDS Data in certain applications.

### SUMMARY OF THE INVENTION

The invention relates to reducing the power consumed by a mobile phone when the RDS Radio is active.

In general, this invention relates to improving the power consumption of a mobile phone or terminal which contains an RDS Radio by aligning the processing of the RDS Radio data with other phone or terminal activities, such as the Bluetooth transceiver activities.

Examples of “other phone activities” include the cellular system (GSM, WCDMA, CDMA), the Bluetooth transceiver, WLAN transceiver (IEEE802.11), or the GPS receiver.

The decoding of the RDS radio data requires software or hardware processing. In some architectures this requires a system clock. This invention is particularly beneficial in systems that require a system clock, as this provides the biggest saving of current. It can also apply to systems that do not require a system clock, as at some point the decoded data will need to be passed to the host processor, and at this time, a system clock will be required.

The exact time at which the RDS data is decoded is not always critical, provided that it occurs within a certain period of time.

To optimise the total power consumed within the phone, it would be advantageous to align the phone activities.

According to one aspect of the invention, there is proposed a method or apparatus wherein the “RDS radio” engine (hardware, software or combination of both) runs whenever the phone is active and/or not in a power-save mode. If there is data to be processed then it will process the data. If there is no data, or the engine has run within a defined period of time, then it does nothing and allows the system to return to the low power mode. If the phone does not become active within a timeout period, then the RDS Radio engine will run. i.e. the RDS Radio engine can be guaranteed to run within a pre-defined period but will opportunistically run whenever it can i.e. when the phone is active. The phone is active whenever the cellular engine is active or when the Bluetooth engine is active or when other phone activities are active.

According to one implementation, the RDS Radio engine will need to know when other blocks within the mobile device are active. This could be through hardware signals or software messages that define when the system is either awake or predict when it will be.

An advantage associated with the invention is the ability to extend the operating time of the phone when the RDS radio is active.

1. Apparatus arranged to have an apparatus active state and an apparatus idle state, the apparatus comprising an RDS engine having an engine active state and an idle state; and wherein the RDS engine is arranged to be placed, in the engine active state based upon whether the apparatus is in the apparatus active state.

2. Apparatus according to claim 1, wherein the apparatus comprises a system clock and wherein the operation of the system clock is associated with the apparatus active state.

3. Apparatus according to claim 1, wherein the apparatus comprises a cellular transceiver and wherein the apparatus active state is associated with the sending/receiving of data via the cellular transceiver.

4. Apparatus according to claim 1, wherein the apparatus comprises a WLAN transceiver and wherein the apparatus active state is associated with the sending/receiving of data via the WLAN transceiver.

5. Apparatus according to claim 1, wherein the apparatus comprises a Bluetooth transceiver and wherein the apparatus active state is associated with the sending/receiving of data via the Bluetooth transceiver.

6. Apparatus according to claim 1, wherein the apparatus comprises a GPS receiver and wherein the apparatus active state is associated with the receiving of data via the GPS receiver.

7. Apparatus according to claim 1, wherein the RDS engine is configured to be placed in the engine active state at periodic intervals.

8. Apparatus according to claim 1, wherein the apparatus is a portable apparatus and comprises a portable power cell to provide power to the apparatus.

9. Apparatus according to claim 1, wherein when the RDS engine is in the engine active state, the RDS engine is arranged to determine whether there is any data to be processed by RDS engine and if not, the RDS engine is returned to an idle state.

10. A method of operating an apparatus, the apparatus arranged to have an apparatus active state and an apparatus idle state, the apparatus comprising an RDS engine having an engine active state and an idle state, and wherein the method comprises placing the RDS engine in the engine active state based upon whether the apparatus is in the apparatus active state.

11. A method according to claim 10, wherein the apparatus comprises a Bluetooth transceiver and wherein the method comprises placing the apparatus in the apparatus active state when sending/receiving data via the Bluetooth transceiver.

12. A method according to claim 10, wherein the apparatus comprises a WLAN transceiver and wherein the method comprises placing the apparatus in the apparatus active state when sending/receiving of data via the WLAN transceiver.

13. A method according to claim 10, wherein the apparatus comprises a GPS receiver and wherein the method comprises placing the apparatus in the apparatus active state when receiving data via the GPS receiver.
